(19) United States
(12) Patent Application Publication
(10) Pub. No.: US 2010/0036064 A1
(43) Pub. Date: Feb. 11, 2010

(54) SEMIBATCH COPOLYMERIZATION PROCESS FOR COMPOSITIONALLY UNIFORM COPOLYMERS

(75) Inventors: Kenneth Wayne Leffew, Kennett Square, PA (US); Troy Wayne Francisco, Bear, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONR DE NEMOURS AND COMPANY, Wilmington (DE)

(21) Appl. No.: 12/515,137

(22) PCT Filed: Dec. 18, 2007
(86) PCT No.: PCT/US07/25801

§ 371 Date: May 15, 2009

Related U.S. Application Data
(60) Provisional application No. 60/876,044, filed on Dec. 19, 2006.

(51) Int. Cl. C08F 2/00; C08F 214/18; C08F 118/02; C08F 16/12; C08F 112/08

(52) U.S. Cl. 526/60; 526/242; 526/319; 526/332; 526/346

(57) ABSTRACT

This invention relates to semi-batch type copolymerization processes. More specifically, the processes of the present invention are directed to the production of compositionally uniform copolymers, including the production of such copolymers from dissimilar monomers, e.g., from monomers with significantly different reactivity ratios.

### FIELD OF THE INVENTION

This invention relates to semi-batch type copolymerization processes. More specifically, the processes of the present invention are directed to the production of compositionally uniform copolymers, including the production of such copolymers from dissimilar monomers, e.g., from monomers with significantly different reactivity ratios.

### BACKGROUND

A semi-batch polymerization process is a modified batch process that seeks to address some of the deficiencies of a standard batch process for polymerization of monomers of different reactivities. In a semi-batch polymerization process, the reaction vessel is initially loaded with only a portion of the monomers and catalyst. Typically, the monomer(s) with lower reactivity will be present at a higher molar ratio during the initial charging of the vessel. As the reaction proceeds and monomers are consumed in the production of the copolymer, more monomers and optionally catalyst are fed to the reactor, at a ratio determined by both the relative reactivities of the monomers and the desired copolymer composition. As is typically practiced for copolymerization processes, this is an open-loop process, i.e., there is no in-situ or real-time analysis to monitor the composition of the reaction mass, and therefore no way to adjust the feed composition to compensate for process upsets.

Closed-loop semi-batch methodology, which is commonly used in commercial processes in the chemical industry, has not been applied to the manufacture of copolymers, in large part due to the lack of suitable analytical techniques for in-situ monitoring of the composition of the reaction mass while the polymerization is in progress. The spectral characteristics of monomers and any polymers produced from these monomers are often quite similar, making it difficult to determine how much of any given monomer has been converted to polymer.

The regulation of the liquid phase composition of a polymerization process in a well-mixed reactor is a difficult process control problem, in large part because the processes are inherently non-linear. The process gains (the change in concentration of a given monomer within the reactor for a unit change in feedrate of one of the monomers) decrease as the reactor fills, and the process time constants (when a change in feedrate is seen in concentration changes in the reactor) increase as the reactor fills. Consequently, conventional linear control systems applied to this problem are inherently unstable. In addition to the inherent non-linearity, control is further complicated by the need to simultaneously regulate multiple process variables.

Closed-loop composition control within a semibatch polymerizer, where in-situ process monitoring is used and where the measured value of the composition is used to continuously adjust the trajectory of the polymerization, has not been previously disclosed. Therefore, there is a need for a copolymerization process that produces compositionally uniform copolymers even from monomers with significantly different reactivity ratios.

### SUMMARY

One aspect of this invention is a polymerization process for reacting monomers in a reaction vessel equipped with a detection system, comprising:
a. charging the reaction vessel with a pre-charge of monomers at a target liquid phase composition;
b. establishing a desired set of reaction conditions in the reaction vessel and an interim liquid phase composition;
c. measuring the interim liquid-phase composition with the detection system to provide interim liquid-phase composition values;
d. using the interim liquid-phase composition values as an input to a constrained predictive model control system; and
e. using output from the control system to adjust feed rates of the monomers to the reaction vessel to maintain the target liquid phase composition.

### BRIEF DESCRIPTION OF THE DRAWINGS

FIG. 1A is a schematic representation of the data collection and analysis equipment useful in one embodiment of this invention.

FIG. 1B is a schematic representation of a polymerization reactor for one embodiment of this invention.

FIG. 2 is a flow diagram for one embodiment of this invention.

FIG. 3 is a graph of monomer flow rates and TFE pressure vs. time for Example 1.

FIG. 4 is a graph of monomer concentrations vs. time for Example 1.

FIGS. 5A are 5B are a set of two micrographs comparing the lithographic performance of Comparative Example A (open loop process) and Example 1 (closed loop process).

FIGS. 6A and 6B are a set of two charts comparing the composition of two polymers—Comparative Example A prepared by an open loop process and Example 1 prepared by a closed loop process of this invention.

FIG. 7 is a graph of monomer concentration vs. time for Comparative Example A.

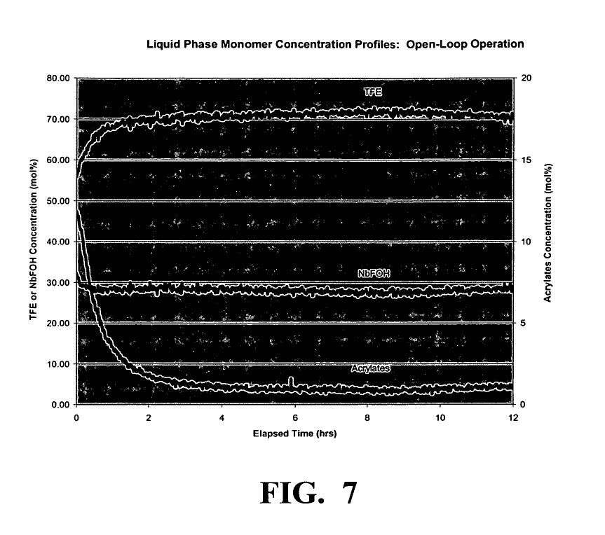

### DETAILED DESCRIPTION

Applicants have developed a semi-batch polymerization process with advanced control and optimization that employs in-situ measurement of comonomer concentrations in the liquid phase and a constrained model predictive control algorithm that adjusts monomer feed-rates to maintain a constant liquid phase composition. This process allows one to maintain a target liquid-phase composition under the constraint that the liquid fill rate is also maintained constant over the course of the polymerization. This constraint maximizes reactor productivity, while ensuring that the reactor will not be overfilled. This process is useful for polymerizing monomers of widely varying polymerization reactivities (relative reactivity ratios greater than 2 or less than 0.5), but it can also be used for monomers of similar reactivities (relative reactivity ratios of between about 0.5 and 2). Examples of such monomers include fluoroolefins wherein the fluorine is attached to a carbon of double bond of the fluoroolefin, acrylates, methacrylates, cyclic olefins, vinyl ethers, and styrenics.

One consequence of the ability to keep the liquid phase composition of the monomers constant is that copolymers made by the process of this invention have more uniformity in composition from chain-to-chain.

The impact of greater uniformity on the performance of the copolymers depends on both the nature of the copolymers and the application in which they are being used. It has been demonstrated, for example, that certain photoresist copolymers made by the process of this invention display improved line-edge roughness compared to copolymers made from the same monomers under standard semi-batch process conditions.

The safety of certain polymerization processes can also be improved using the process of this invention, without sacrificing productivity. In a semi-batch reactor, and particularly when one of the reactants is toxic and/or prone to deflagration (e.g., TFE), it is important from a process safety perspective that the reactor not be overfilled during the feed stage of the process. Conversely, from an economic perspective it is highly desirable that the reactor be utilized to its maximum potential in each batch. Conventional, linear control systems cannot handle such constraints.

The process of this invention combines the use of a constrained model-predictive controller (CMPC) with appropriate spectroscopic or other analytic techniques to provide a system that is capable of maintaining the desired monomer concentrations throughout the course of a semi-batch copolymerization process. Commercial software packages are available from a number of sources, including Adersa (program HIECON, Paris, France); Cutler Technology Corp. (program DMC, San Antonio, Tex.); Honeywell (program RMPCT, Morris Township, N.J.); Aspentech (program DMCPlus, Houston, Tex.); and The Mathworks, Inc. (program MPCMOVE, Natick, Mass.).

As explained by P. B. Deshpande, et al., Chemical Engineering Progress, 91, 3, 1995, pp. 65-72, CMPC is a linear digital computer control algorithm developed for advanced control and optimization of linear multivariable, continuous systems. A subset of model predictive control, CMPC utilizes an explicit dynamic model to predict the state of the controlled plant at some time in the future. [ONLINE]™ from Six Sigma and Advanced Controls, Inc. incorporates traditional feedback, advanced controls, and constrained optimization into a single software application. CMPC can accommodate both square (number of manipulated variables (MVs) equals the number of process output variables (PVs)) and non-square (number of MVs not equal to the number of PVs) systems. When the number of PVs exceeds the number of MVs, CMPC regulates the controlled variables within user-specified bounds. When the number of MVs exceeds the number of PVs, the MVs may be allocated on the basis of a suitable economic optimization objective. In the latter scenario, it becomes possible to maximize throughput, minimize energy consumption, improve quality control, and improve the yield of more valuable products as desired.

Linear dynamic process models are the backbone of CMPC; a step-response model is used in [ONLINE]™. Step response models are developed from a two-step experimental process identification procedure. In the first, with the process operating at the normal operating condition, manipulated variables (MVs) are moved in both directions (above and below starting values) for suitable durations and the resulting input (MVs plus measured disturbances, if any) and output (PVs) data are recorded. In the second step, the resulting data are analyzed to obtain the open-loop step response model of the multivariable process. The sampling frequency (equivalently, sampling interval) is selected such that the slowest dynamics in the multivariable system are accurately represented.

The stepwise procedure for implementing CMPC on the process is as follows:
1. At each sampling interval, use the step response models to predict the values of all process outputs (PVs) for P sampling intervals into the future. The parameter P is called the prediction horizon.
2. On the basis of the current process output measurements, correct the vector of predicted process outputs in step 1, thus accounting for the presence of unmeasured disturbances and modeling errors.
3. Compare the corrected future process outputs with the set point trajectory to generate a vector of future errors.
4. Solve a constrained optimization problem to compute a set of M controller movements (MVs) such that a user-selected optimization index is satisfied subject to all operating constraints on the manipulated variables and the process outputs. The parameter M is called the control horizon.
5. Apply the first of these M moves in each of the manipulated variables to the process and repeat steps (1) through (4) at the next sampling interval.

The parameters, N (longest open-loop settling time), M (control horizon) and P (prediction horizon) have a bearing on controller responsiveness and robustness (ability to maintain stability in the presence of a plant-model mismatch). With proper choices of these parameters, perfect control (minimum variable control) can be specified. However, in this instance, excessive movements of the manipulated variables result and the system can become unstable in the presence of modeling errors. If P is set equal to N+M, as is frequently done, the computations are simplified and a high-performance controller with desirable robustness properties results.

The constrained model predictive controller contains a number of parameters for specifying operational objectives.
The upper and lower limits of the process outputs specify the targets. A unique set point is specified by setting the upper limit equal to the lower limit. Different values specify the bounds within which the process outputs are to be contained. The controller first tries to regulate the process outputs within their respective bounds. If it can do so, it focuses on achieving the economic objectives specified with the cost coefficients.
Weights associated with the process outputs are used to prioritize their relative importance. By assigning a larger value for selective weighting for a specific MV, tighter control of that MV relative to the others will be obtained.
The upper and lower limits on the manipulated variables specify the bounds on the manipulated variables, which CMPC will not violate.
The cost coefficients (or move penalties) associated with the manipulated variables allow for their allocation on the basis of economic criteria specified in the objective function.
Maximum move sizes. The CMPC software will not violate the maximum change in the manipulated variables specified from one sampling interval to the next.

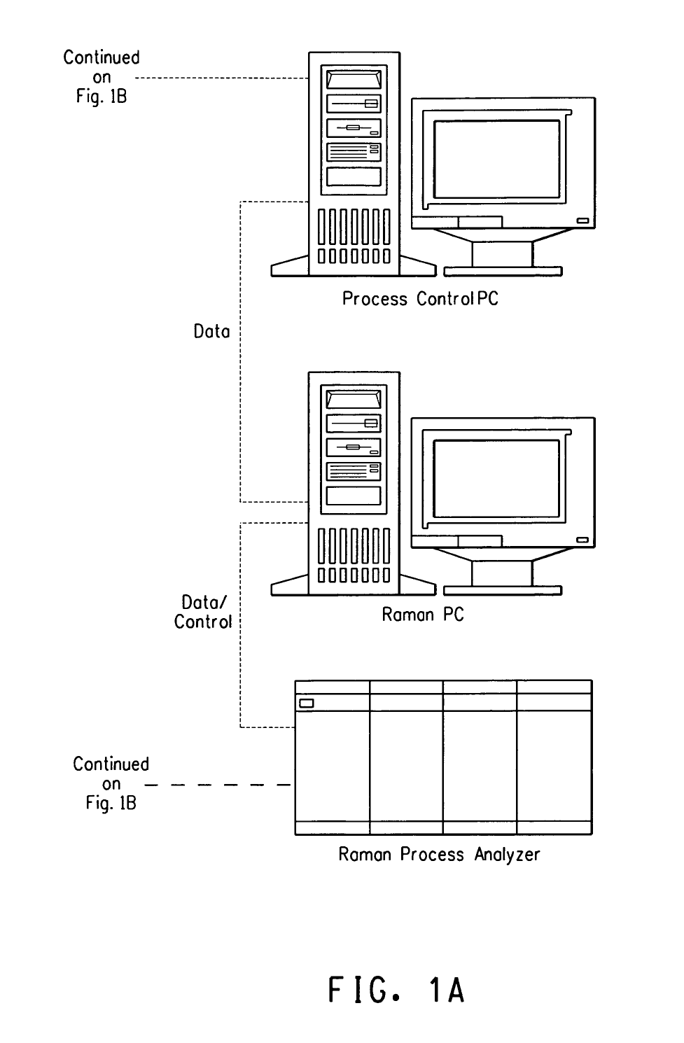

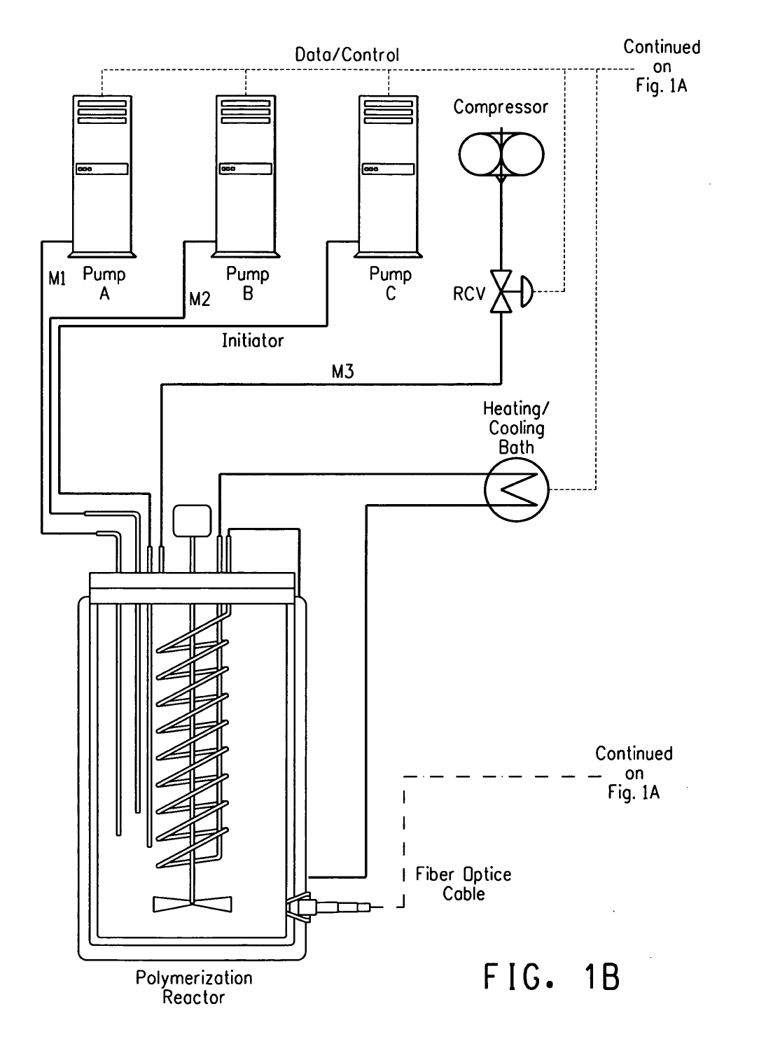

A reactor, detector and control system useful in one embodiment of this invention are shown schematically in FIGS. 1A and 1B. This example configuration uses two liquid-phase monomers and one gas phase monomer. In this configuration, one of the liquid-phase monomers (designated M1 in FIG. 1B) is fed to the semi-batch reactor vessel with Pump A. The in-reactor monitoring system measures the concentration of this monomer. The other liquid phase monomer (M2) is fed into the polymerization reactor with Pump B. The polymerization initiator is fed to the reactor with pump C. The gas phase monomer is added to the reactor by means of a compressor through a pressure control valve (PCV in FIG. 1A) and some of this monomer is dissolved into the liquid phase and is also monitored by the in-reactor monitoring system. In this embodiment, the concentrations of the monomers in the liquid phase and the total flow rate of liquid phase monomer solutions into the reactor are kept on target by the CMPC controller by manipulating the set points of local controllers that maintain the monomer solution flows from Pump A and Pump B and the reactor pressure. The reactor pressure determines the amount of gas-phase monomer fed to the reactor which dissolves into the liquid phase. The liquid phase composition is analyzed by Raman spectroscopy through a transparent window in the reactor vessel. Raman scattered light from the liquid phase composition is transmitted through the transparent window, generating Raman signals that are transmitted to the Raman process analyzer. Raman signal data is collected periodically during the course of the reaction to determine the interim liquid phase compositions.

Temperature control in the reactor is maintained by use of a combination internal/external heating/cooling system.

In other embodiments, Pump A and/or Pump B can contain mixtures of two or more monomers.

As is shown in FIG. 1A, Raman signals are analyzed in the Raman process analyzer, and then sent to a Raman PC for conversion to composition information. The composition information is then sent to a process control PC to implement CPMC on the process.

The target liquid phase composition for the polymerization is determined a priori for a given target copolymer composition through the use of the classical polymer equation and is dependent upon the relative reactivities of each of the polymerizing monomers. The wider the disparity in reactivity ratios of the monomers, the more the target liquid phase composition will vary from the target copolymer composition. The monomer reactivity ratios can be obtained from kinetic studies of pair-wise copolymerizations or from non-linear parameter estimation techniques. Both of these techniques are well-known to those skilled in the art.

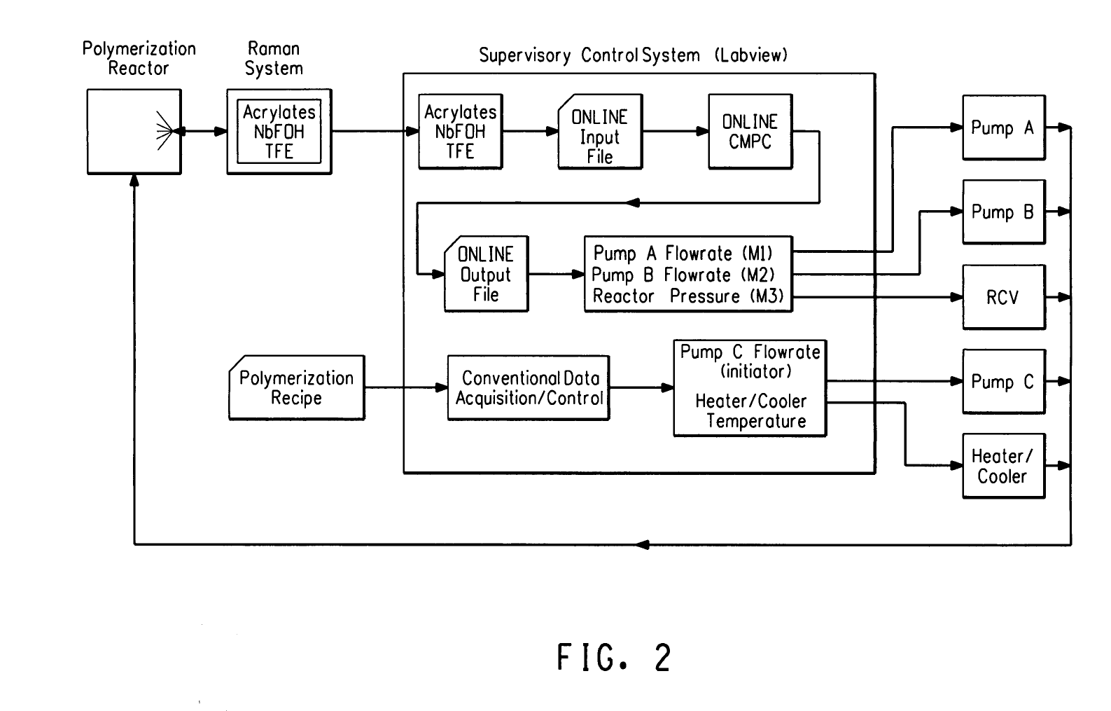

A block diagram of one embodiment of the invention is shown in FIG. 2.

To illustrate how the target liquid phase composition is determined, we consider a terpolymer of TFE, NB—F—OH and tBA. The polymer equation for this terpolymer is given below:

$${P}_{TFE} : {P}_{NbFOH} : {P}_{tBA} = [ TFE ] \{ \frac{[ TFE ]}{{r}_{31} {r}_{21}} + \frac{[ NbFOH ]}{{r}_{21} {r}_{32}} + \frac{[ tBA ]}{{r}_{31} {r}_{23}} \} \{ [ TFE ] + \frac{[ NbFOH ]}{{r}_{12}} + \frac{[ tBA ]}{{r}_{13}} \} \text{:} [ NbFOH ] \{ \frac{[ TFE ]}{{r}_{12} {r}_{31}} + \frac{[ Nb FOH ]}{{r}_{12} {r}_{32}} + \frac{[ tBA ]}{{r}_{32} {r}_{13}} \} \{ [ NbFOH ] + \frac{[ TFE ]}{{r}_{21}} + \frac{[ tBA ]}{{r}_{23}} \} \text{:} [ tBA ] \{ \frac{[ TFE ]}{{r}_{13} {r}_{21}} + \frac{[ NbFOH ]}{{r}_{23} {r}_{12}} + \frac{[ tBA ]}{{r}_{13} {r}_{23}} \} \{ [ tBA ] + \frac{[ TFE ]}{{r}_{31}} + \frac{[ NbFOH ]}{{r}_{32}} \}$$

The reactivity ratios (r₃₁r₂₁, r₂₁r₃₂, r₃₁r₂₃, etc.) were obtained from a series of batch polymerizations. Using the equation above, the required target liquid phase composition (i.e., concentration of TFE, NB—F—OH and tBA) can be calculated for each target copolymer composition (P_{TFE}:P_{NB—F—OH}:P_{tBA}).

| Target Copolymer Composition | | | Required Liquid Phase Composition | | |
|---|---|---|---|---|---|
| (mol %) | | | (mol %) | | |
| TFE | NB—F—OH | tBA | TFE | NB—F—OH | tBA |
| 10 | 20 | 70 | 37.03 | 20.86 | 42.11 |
| 20 | 20 | 60 | 47.21 | 19.70 | 33.10 |
| 30 | 50 | 20 | 51.18 | 43.57 | 5.26 |
| 30 | 40 | 30 | 53.35 | 36.99 | 9.99 |
| 30 | 30 | 40 | 54.59 | 28.47 | 16.94 |
| 30 | 20 | 50 | 54.27 | 19.50 | 26.22 |
| 30 | 10 | 60 | 52.33 | 10.06 | 37.61 |
| 40 | 20 | 40 | 59.97 | 19.87 | 20.17 |
| 50 | 20 | 30 | 64.81 | 20.73 | 14.45 |

If, for example, the target copolymer composition were 30 mol % TFE, 20 mol % NB—F—OH and 50 mol % tBA, then the liquid phase composition should be 54.27 mol % TFE, 19.50 mol % NB—F—OH, and 26.22 mol % tBA throughout the entire course of the polymerization.

The control strategy regulates copolymer composition throughout the course of the reaction by controlling the liquid phase composition in the reactor via manipulation of the feed rates of monomer solutions into the reactor. The initiator feed rate is not manipulated by the control system, but rather the feed profile of initiator is established in advance of the run.

In one embodiment of the process of this invention, the reactor is filled to a level at which an in-line sensor can be fully wetted with a monomer mixture that has the target liquid phase composition. Additional portions of each monomer are added to the reactor over the course of the polymerization at the rate at which each monomer is being converted into polymer.

In one embodiment of this invention, [ONLINE]™ resets the flow set-points of non-volatile monomers and the pressure set-point to regulate the controlled variables, e.g., mole percents of non-volatile monomers and total monomer liquid flow at the predetermined targets.

The total monomer liquid flow is a summation of the monomer solution feeds and is calculated on a predetermined frequency within the data acquisition and control software (for example, LabView® data acquisition and control software from National Instruments, Austin, Tex.). The set-point for total monomer liquid flow is calculated manually before each run based upon the initial reactor charge, V₀, the desired final reactor charge, V_{f}, the duration of the polymerization, t_{P}, and the calculated total liquid phase absorption of TFE, V_{TFE}:

$$F = \frac{⌊ {V}_{f} - {V}_{0} - {V}_{TFE} ⌋}{{t}_{P}}$$

By constraining the total liquid flow rate into the reactor in this manner, the process has a measure of inherent process safety in that the system will aggressively attempt to manipulate the flow rates to achieve the desired compositional set-points, but it will, by definition, not result in either overfilling or underfilling the reactor.

The process of this invention can be used to make a variety of TFE copolymers. The molecular weight of TFE copolymers can be effectively controlled through the addition of a chain transfer agent (e.g., THF), the manipulation of the reaction temperature, or the rate of addition of free radical initiator. All of these methods for molecular weight control are well-known in the batch polymerization art. In one embodiment of this invention, a combination of initiator concentration and chain transfer agent concentration is used to regulate polymer molecular weight.

While one embodiment of this invention involves the polymerization of dissolved TFE with acrylate-type monomers, one skilled in the art would readily recognize the utility of the method to the free radical co-polymerization of other types of monomers, including styrenics and olefinics.

In one embodiment of this invention, the in-situ measurements are made by Raman spectroscopy. Equivalently, any in-line device that provides a measure of the molar composition of the liquid phase (FTIR, NIR, densitometry, GC, etc.) could be utilized.

### EXAMPLES

Unless otherwise noted, all compositions are given as mole %.

### Chemicals/Monomers

TFE Tetrafluoroethylene
   E. I. du Pont de Nemours and Company, Wilmington, Del.
NB—F—OH

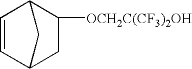

HAdA 3-hydroxy-1-adamantyl acrylate (Idemitsu Japan, Tokyo, Japan)
PinAc 2-Propenoic acid, 2-hydroxy-1,1,2-trimethylpropyl ester [CAS Reg # 97325-36-5]
tBA tertiary butyl acrylate
Solkane® 365 mfc 1,1,1,3,3-Pentafluorobutane (Solvay, Hannover, Germany)

### Example 1

### Closed-Loop Copolymerization of TFE, NB—F—Oh and Acrylates (PinAc and HAdA)

This example illustrates closed-loop composition control of a semi-batch copolymerization, in which the monomers display reactivity ratios that range from 0.059 to 47.4.

In particular, this example illustrates the copolymerization of acrylates (HAdA and PinAc), TFE, and norbornene fluoroalcohol (NB—F—OH), with closed-loop control of composition over the course of the reaction. The target copolymer composition for this example was 21% TFE, 41% NB—F—OH, 21.6% PinAc, and 16.4% HAdA, with a weight average molecular weight (Mw) of 35,700. The final polymer concentration in the solvent was targeted to be 30 wt % and the reactor was targeted to be 67.56% filled at the end of the polymerization, 12 hr after beginning the monomer and initiator flows. From the reactivity ratios of these four monomers, it was calculated that the target polymer composition would require a liquid phase composition of 40.09% TFE, 43.78% NB—F—OH, and 16.14% acrylates.

The polymerization reaction utilized four monomers in three separate streams: NB—F—OH (in methyl acetate solvent), acrylates (HAdA and PinAc at a molar ratio of 21.6/16.4) in methyl acetate solvent, and TFE (gas). Isco® screw pumps were used to feed the two liquid monomer solutions, and TFE was fed into the polymerization reactor via a pressure control loop. An Isco® pump was also used to feed the initiator solution.

The polymerization reactor was a one gallon (Inconel® 600) vessel (from Autoclave Engineers, Erie, Pa.) pressure-rated for 1500 psig at 343° C. and equipped with a cooling/heating jacket in series with an internal cooling coil and an internal agitator. The reactor was also equipped with an imaging Raman spectrometer, Kaiser Optical Systems model RNX1-785.

Raman spectroscopic data were collected through a sapphire viewport on the reactor and transmitted via a fiber optic cable to the Raman computer and analyzed using univariate and multivariate calibration models, based on linear regression and partial least squares algorithms, respectively, to estimate of the mole fractions of TFE, NB—F—OH and total acrylates on an analysis cycle of 60-80 sec.

The mole fraction measurements were passed to a supervisory process control and data acquisition system (written in Labview® software, National Instruments, Austin, Tex., and implemented on a personal computer) via hardwired serial communication. Real-time control of the copolymer composition produced in the process was achieved through a software-implemented constrained model predictive controller (CMPC) provided by SAC, Inc. (Louisville, Ky.) and referred to as ONLINE™. This algorithm compared the measured values of NB—F—OH and acrylate concentrations with the target values and calculated changes to the setpoints of the flow rates of these two monomer solutions and the reactor pressure setpoint that would satisfy the objective function of the control algorithm. The resultant setpoint changes were transferred to the supervisory process control software in Labview®, and then to the local pump controllers that regulated the solution flow rates to the reactor and to a local pressure controller that regulated the control valve in the TFE supply line to the reactor.

### Polymerization Process

The polymerization reactor was purged with N₂. TFE was then delivered to the reactor until the pressure reached 70 psig and then was vented from the reactor. This cycle of pressurization with TFE followed by venting was repeated six times. After the sixth cycle, the reactor pressure was vented to 5 psig.

Using Isco® pump A, the reactor was charged with a solution made up of 322 g NB—F—OH, 10 g PinAc, 12 g HAdA and 426 g methyl acetate, an amount sufficient to cover the bottom blades of the stirrer. Residual precharge solution from pump A and from the delivery lines were drained into a collection vessel. The Raman system was turned on and measurement of the composition of the liquid phase within the reactor was obtained from this system once every 60 seconds for the duration of the reaction.

Isco® pump A was then filled with monomer solution M1 (66.8 wt % NB—F—OH in methyl acetate) and a small amount of this solution was used to purge the delivery line of any residual precharge solution.

Isco® pump B was filled with monomer solution M2 (27.7 wt % PinAc and 33.0 wt % HAdA in methyl acetate) and a small amount of this solution was used to purge the delivery line of any residual solution from previous runs.

Isco® pump C was filled with initiator solution (4.6 wt % Perkadox® 16 N,di-(4-tert-butylcyclohexyl)peroxydicarbonate, Noury Chemical Corp., Burt, N.Y. in methyl acetate) and a small amount of this solution was used to purge the delivery line of any residual solution from previous runs.

The agitator drive on the reactor was then turned on and adjusted to obtain an agitation rate of 500 rpm. The Julabo® heater/cooler unit was then turned on and the setpoint was adjusted to 50° C.

When the reactor temperature was stabilized at 50° C., the pressure controller for reactor pressure was set to 210 psig, the TFE compressor was turned on and the flow of TFE gas to the reactor was initiated.

When both the reactor temperature and pressure were stabilized at their setpoint conditions, all three Isco® pumps were turned on. The starting flow rate for pump A was 1.247 cc/min, for Pump B was 0.590 cc/min and for Pump C was 4.64 cc/min. Six minutes after the beginning of initiator flow, the setpoint for initiator flow from Pump C was changed to 0.19 cc/min. In this manner, the total amount of Perkadox® (5 g) fed into the reactor was distributed so that 23.8% entered in the first 6 minutes and the remainder entered at a constant rate for 8 hr.

The initial setpoint for the liquid phase composition (as measured by the Raman instrument after the flow rate of Perkadox® was established) was 67.3% TFE, 30.0% NB—F—OH and 2.7% acrylates based on previous polymerizations.

The setpoints for Pump A and B flow rates and reactor pressure were updated every 7 minutes over the course of the polymerization as determined by the ONLINE™ CMPC algorithm in response to the signal obtained from the Raman system.

The configuration of the CMPC [ONLINE]™ is shown in Table 1. The ONLINE™ controller was set to begin the feed rate of M1 at 1.25 cc/min and the feed rate of M2 at 0.59 cc/min. The total flow rate constraint was set to 1.84 cc/min.

TABLE 1
Configuration of CMPC [ONLINE] ™ for Example 1

| | |
|---|---|
| Sampling interval, minutes | 7 |
| Number of process outputs (PVs) | 3 |
| Number of manipulated variables (MVs) | 3 |
| Number of sampling intervals in longest open loop settling time | 120 |
| (N) | |
| Length for optimization (M), number of sample times | 8 |
| Upper bound on PV#1, NB-F-OH conc (mol %) | 26.77 |
| Lower bound on PV#1, NB-F-OH conc (mol %) | 26.77 |
| Upper bound on PV#2, Acrylates conc (mol %) | 2.7 |
| Lower bound on PV#2, Acrylates conc (mol %) | 2.7 |
| Upper bound on PV#3, Total monomer soln flow rate, cc/min | 1.874 |
| Lower bound on PV#3, Total monomer soln flow rate, cc/min | 1.800 |
| Start-up value for MV#1, M1 flow rate, cc/min | 1.247 |
| Upper bound on MV#1, M1 flow rate, cc/min | 2.000 |
| Lower bound on MV#1, M1 flow rate, cc/min | 0.600 |
| Start-up value for MV#2, M2 flow rate, cc/min | 0.590 |
| Upper bound on MV#2, M2 flow rate, cc/min | 1.200 |
| Lower bound on MV#2, M2 flow rate, cc/min | 0.200 |
| Start-up value for MV#3, Reactor pressure setpoint, psig | 210 |
| Upper bound on MV#3, Reactor pressure setpoint, psig | 260 |
| Lower bound on MV#3, Reactor pressure setpoint, psig | 160 |
| Selective weighting for PV#1 (NB-F-OH conc) | 1 |
| Selective weighting for PV#1 (Acrylates conc) | 1 |
| Selective weighting for output 3 (Total monomer soln flow rate) | 25 |
| Move penalty for MV#1 (M1 flow rate) | 2 |
| Move penalty for MV#2 (M2 flow rate) | 2 |
| Move penalty for MV#3 (Reactor pressure setpoint) | 1 |
| Max Move Size on MV#1, M1 flow rate, cc/min | 0.140 |
| Max Move Size on MV#2, M2 flow rate, cc/min | 0.100 |
| Max Move Size on MV#3, Reactor pressure setpoint, psig | 5 |

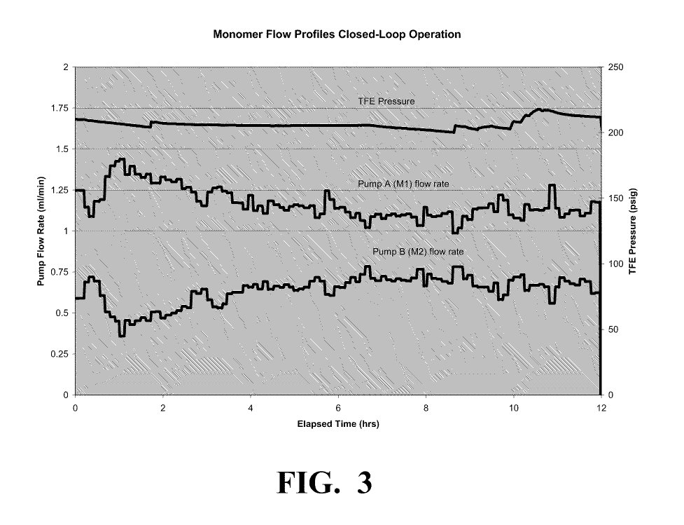

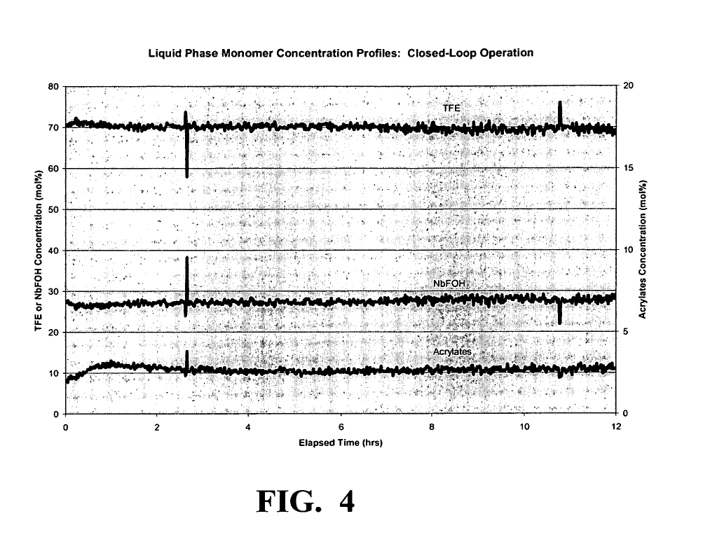

The setpoint trajectory dictated by ONLINE™ over the course of the reaction is indicated in FIG. 3. The resultant liquid phase composition trajectory as measured by the Raman system is shown in FIG. 4. Over the course of the polymerization, 704 measurements of composition were made by the Raman system at a frequency of roughly one sample every minute. The resultant statistics on the liquid phase composition are shown in Table 2.

TABLE 2
Raman System Statistics for Example 1

| | Setpoint | Average | Std. Dev. |
|---|---|---|---|
| Component | (mol %) | (mol %) | (mol %) |
| TFE | 70.0 | 69.95 | 0.73 |
| NB-F-OH | 27.3 | 27.37 | 0.69 |
| HAdA/PinAc | 2.7 | 2.68 | 0.17 |

The total amount of each monomer fed to the reactor is shown in Table 3.

TABLE 3
Total Liquid Phase Feeds over the Course of Polymerization

| | Mol % | Wt % | Vol % | Total | Total | Total |
|---|---|---|---|---|---|---|
| | in | in | in | Volume | Mass | Moles |
| Component | Liquid | Liquid | Liquid | Fed (cc) | Fed (g) | Fed |
| TFE | 40.1% | 19.8% | 25.4% | 348 | 324 | 3.24 |
| NB—F—OH | 43.8% | 62.8% | 55.5% | 760 | 1026 | 3.54 |
| PinAc | 9.2% | 7.8% | 8.6% | 118 | 127 | 0.74 |
| HAdA | 7.0% | 9.5% | 10.5% | 144 | 156 | 0.57 |
| Total | — | — | — | 1370 | 1633 | 8.09 |
| Monomer | | | | | | |

Eight hours after the initiator flow rate was changed to 0.19 cc/min, Pump C was turned off. Twelve hours after the monomer solutions started to flow to the reactor, Pumps A and B were turned off. At the same time, the TFE flow was turned off and the reactor was vented in 20 psi increments every 10 minutes until the reactor pressure reached 40 psig. When the TFE pressure reached 40 psig, the setpoint on the Julabo® heater/cooler was reduced to 25° C. When the reactor temperature reached 25° C., the remaining pressure on the vessel was discharged through the TFE vent line and the agitator motor was turned off. Nitrogen was then added to the reactor until the pressure reached 10 psig.

The solution in the reactor was then discharged to provide 2781 g of golden yellow, slightly cloudy polymer solution, with a liquid density of 1.39 g/L, an Mw of 32,700, and a polydispersity (Mw/Mn) of 2.02. The polymer solution was precipitated into heptane (at 18/1 volume ratio of heptane to polymer solution), and 472 g of white polymer was isolated This polymer was redissolved in Solkane® 365 mfc/THF mixture (50/50 wt ratio) and then reprecipitated in heptane to yield 433 g of final dry product. Gel permeation chromatography of this final dry product indicated that the Mw was 34,500, with a polydispersity of 1.86. The polymer composition was determined to be 8.6% TFE/30.9% NB—F—OH/30.9% PinAc/29.6% HAdA by NMR analysis.

### Lithography Process

A 12 wt % solids formulation of final dry polymer (97.88 g), triphenylsulfonium nonaflate (2.00 g), and tetrabutylammonium lactate (0.12 g) was prepared in 2-heptanone and stirred overnight.

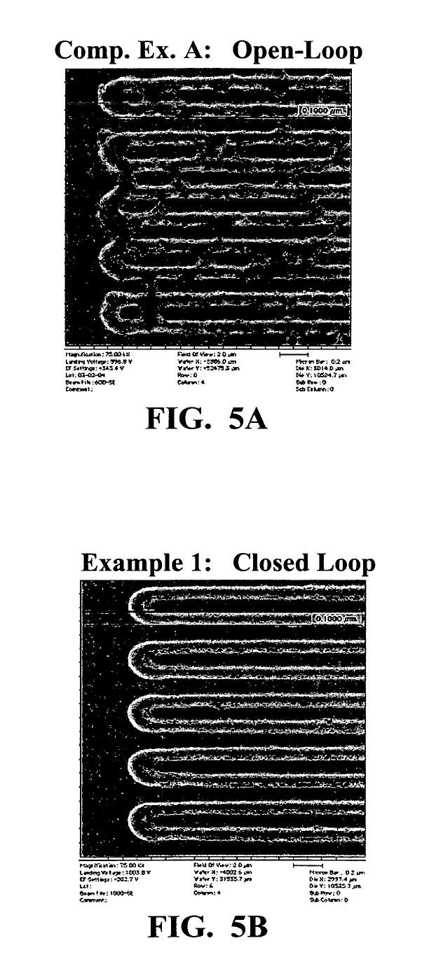

Imaging was done in clean room facilities. A TEL ACT 8 coat/bake/develop track from Tokyo Electron Company, Tokyo, Japan was used to coat and process the formulation. The formulation was hand dispensed onto an 8′ Si wafer primed with 82 nm AR19 antireflective coating from Rohm and Haas Electronic Products, Marlborough, Mass., spun at 1764 rpm to give a film ˜270 nm thick. Subsequent to spinning, the coated wafer was baked at 150° C. for 60 sec. The wafer was then imaged using a SVG Micrascan 193 stepper from ASML, Veldhoven, the Netherlands, set up with illumination optics having NA=0.60 and Sigma=0.3. An alternating phase-shift mask (AltPSM) having a variety of patterns, among them being 100 nm 1:1 lines, provided the image. A serpentine pattern of exposures at 0.5 mJ dose increments was created. After imaging, the wafer was baked at 135° C. for 60 sec and developed for 60 sec in Clariant® 300MIF 2.38% developer (AZ Electronic Materials, Branchburg, N.J.). A Scanning Electron Microscope (SEM) from KLA Tencor, San Jose, Calif., model number 8100 CD, was then used to identify optimum exposure for this pattern and create the image shown in FIG. 5.

### Comparative Example A

### Open-Loop Copolymerization of TFE, NB—F—OH and Acrylates (PinAc and HAdA)

As in Example 1, the target copolymer molar composition was 21% TFE, 41% NB—F—OH, 38% total acrylates (21.6% PinAc and 16.4% HAdA), with an Mw of 35,700. The final polymer concentration in the solvent was targeted to be 30 wt % and the reactor was to be 67.56% filled at the end of the polymerization, 12 hours after beginning the monomer and initiator flows. However, in this example, the flow rate of liquid monomer solutions and the setpoint for the reactor pressure maintained by TFE gas flow were held constant over the course of the reaction (open-loop mode). This example illustrates the conventional procedure that is followed for the semi-batch copolymerization of monomers which display reactivity ratios that are far from unity.

### Polymerization Process

The precharge, monomer solutions (M1 and M2) and initiator solution make-up were the same as those of example 1. The polymerization was also conducted in the same way, with the exception that the ONLINE™ controller was not engaged. The monomer flow rate and reactor pressure setpoints were maintained constant through the course of the polymerization at that level determined in example 1 to be the start-up conditions:

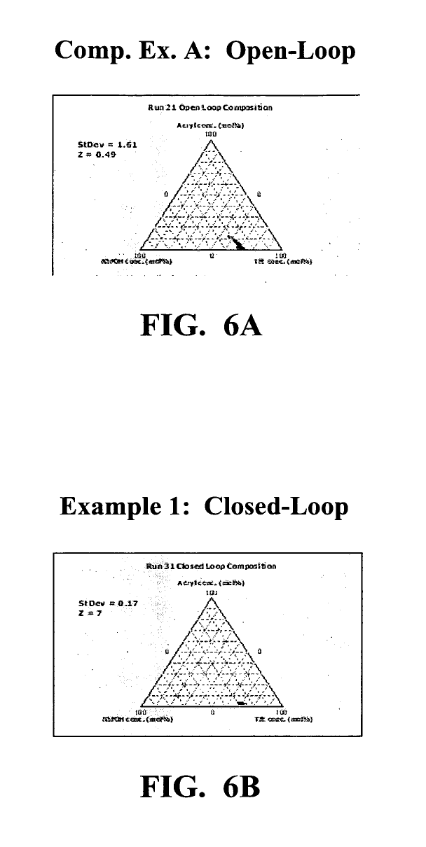

M1 flow rate=1.25 cc/min
M2 flow rate=0.59 cc/min
Reactor pressure=210 psig
The resultant liquid phase composition trajectory as measured by the Raman system is shown in FIG. 6.

Over the course of the polymerization, 720 measurements of composition were made by the Raman system at a frequency of roughly one sample every minute. The resultant statistics on the liquid phase composition are shown in Table 4.

TABLE 4
Raman System Statistics for Comparative Example A

| | Setpoint | Average | Std. Dev. |
|---|---|---|---|
| Component | (mol %) | (mol %) | (mol %) |
| TFE | n/a | 70.28 | 2.20 |
| NB-F-OH | n/a | 28.09 | 0.67 |
| HAdA/PinAc | n/a | 1.63 | 1.80 |

The solution in the reactor was then discharged to provide 4350 g of golden yellow, slightly cloudy polymer solution, with a liquid density of 1.39 g/L, a Mw of 24,000, and a polydispersity (Mw/Mn) of 3.15. The polymer solution was precipitated into heptane (at 18/1 volume ratio of heptane to polymer solution), to yield 682 g of white polymer. The polymer was redissolved in Solkane® 365 mfc/THF mixture and then reprecipitated in heptane to yield 646 g of final dry product, with an Mw of 24,700 and a polydispersity of 2.77. NMR evaluation indicated that the polymer composition was 13.2% TFE, 34.4% NB—F—OH, 23.2% PinAc, and 29.2% HAdA.

### Lithography Process

A 12 wt % solids formulation of final dry polymer (97.88 g), triphenylsulfonium nonaflate (2.00 g), and tetrabutylammonium lactate (0.12 g) was prepared in 2-heptanone and stirred overnight

Preparation of a coated wafer and subsequent imaging was carried out as described above for Example 1. The image is shown in FIG. 5.

We claim:

1. A polymerization process for reacting monomers in a reaction vessel equipped with a detection system, comprising:
a. charging the reaction vessel with a pre-charge of monomers at a target liquid phase composition;
b. establishing a desired set of reaction conditions in the reaction vessel and an interim liquid phase composition;
c. measuring the interim liquid-phase composition with the detection system to provide interim liquid-phase composition values;
d. using the interim liquid-phase composition values as an input to a constrained predictive model control system; and
e. using output from the control system to adjust feed rates of the monomers to the reaction vessel to maintain the target liquid phase composition.

2. The process of claim 1, wherein the detection system comprises a Raman spectroscopy process analyzer, an imaging or immersible probe that collects Raman scattered light from the liquid phase composition, and a connection port on the reactor that allows optical contact between the probe and the liquid phase composition in the reactor.

3. The process of claim 1, wherein the monomers are selected from the group consisting of fluoroolefins wherein fluorine is attached to a carbon of the double bond of the fluoroolefin, acrylates, methacrylates, cyclic olefins, vinyl ethers, and styrenics.

4. The process of claim 3, wherein the cyclic olefin is NB—F—OH.

5. The process of claim 3, wherein the fluoroolefin is TFE.

6. The process of claim 1, wherein the monomers have relative reactivity ratios between 0.5 and 2.

7. The process of claim 1, wherein the monomers have relative reactivity ratios greater than 2 or less than 0.5.

8. Polymers prepared by the process of any of claims 1-7.
